(19) United States
(12) Patent Application Publication
(10) Pub. No.: US 2025/0305709 A1
(43) Pub. Date: Oct. 2, 2025

(54) THERMOSTAT BACKPLATE

(71) Applicant: Google LLC, Mountain View, CA (US)

(72) Inventors: Justin Wodrich, Los Gatos, CA (US); Aaron Chen, Taipei (TW); Wilson Chou, New Taipei (TW); Timothy Lai, San Jose, CA (US)

(73) Assignee: Google LLC, Mountain View, CA (US)

(21) Appl. No.: 18/923,332

(22) Filed: Oct. 22, 2024

Related U.S. Application Data
(63) Continuation-in-part of application No. 18/616,681, filed on Mar. 26, 2024.

(51) Int. Cl. F24F 11/89; F24F 11/52; F24F 11/70; F24F 11/88

(52) U.S. Cl. CPC F24F 11/89; F24F 11/52; F24F 11/70; F24F 11/88

(57) ABSTRACT

Various arrangements of a thermostat backplate are presented herein. A housing configured to be attached with a wall and removably attached with a thermostat can be present. The backplate can include wire receptacles that receive a plurality of HVAC wires that are electrically connected with an HVAC system. The backplate can include power circuitry, housed by the housing, that is configured to output power when a power wire and a control wire are powered and connected with the correct wire receptacles of the backplate. The backplate further includes a light that illuminates using power obtained from the power circuitry.

### CROSS-REFERENCE TO RELATED APPLICATION

This application is a continuation-in-part of U.S. application Ser. No. 18/616,681, filed Mar. 26, 2024, titled: “SMART THERMOSTAT,” which is hereby incorporated by reference in its entirety for all purposes.

### BACKGROUND

A thermostat is used to control the operation of a heating system, cooling system, or both. Users can benefit from using an electronic device that can communicate via a wireless network with a cloud-based server. Such wireless network connectivity can allow for the thermostat to be controlled remotely by a user, such as via an application executed on a user's mobile device. The more straightforward and easy to interact with an electronic device is, the more likely users will desire to interact with the smart thermostat and take advantage of its features.

Installation of a thermostat can be challenging for a non-professional. Proper installation of a thermostat can involve performing tasks that the user does not perform frequently, including disabling power to a portion of a home and properly attaching wires with the proper connectors of a thermostat. Frequently, users make installation errors, such as forgetting to re-enable power to the circuit with which the thermostat is connected, failing to fully connect a wire with the thermostat, or connecting a wire to the wrong receptacle of the thermostat. These errors can result in time-consuming trouble shooting to identify the issue, often with a customer service representative of the thermostat company required to be provide guidance.

### SUMMARY

In some embodiments, a smart thermostat system is presented. The system can include a thermostat head unit. The system can include a thermostat backplate configured to be removably attached with the thermostat head unit. The thermostat backplate can include a plurality of wire receptacles that receive a plurality of HVAC wires that are electrically connected with an HVAC system. The thermostat backplate can include power circuitry that is configured to output power when a power wire is powered and the power wire and a control wire of the plurality of HVAC wires are connected with correct wire receptacles of the plurality of wire receptacles of the thermostat backplate. The thermostat backplate can include a light that illuminates using power output by the power circuitry.

Embodiments of such a smart thermostat system can include one or more of the following features: The thermostat backplate can include control circuitry configured to disable illumination of the light. The control circuitry can be configured to disable illumination of the light in response to the thermostat head unit being attached to the thermostat backplate.

The thermostat backplate can include a level. The light can be positioned on the thermostat backplate to illuminate the level. The power wire can be an Rh wire and the control wire can be a W wire. The power wire can be an Rc wire and the control wire can be a Y wire. The power circuitry can include an AC/DC bridge rectifier configured to convert AC received via the plurality of HVAC wires to DC. The power circuitry can include a step-down voltage converter. The thermostat backplate only receives power from the plurality of HVAC wires and has no onboard battery. The system can further include the HVAC system, which may output a 24 V alternating current via the power wire, and the HVAC system can include a heating system, a cooling system, or both.

In some embodiments a thermostat backplate is presented. The backplate can include housing configured to be attached with a wall and removably attached with a thermostat head unit. The backplate can include a plurality of wire receptacles, housed by the housing, that receive a plurality of HVAC wires that are electrically connected with an HVAC system. The backplate can include power circuitry, housed by the housing, that is configured to output power when a power wire and a control wire of the plurality of HVAC wires are powered and connected with correct wire receptacles of the plurality of wire receptacles of the thermostat backplate. The backplate can include a light, housed by the housing, that illuminates using power obtained from the power circuitry.

Embodiments of such a backplate can include one or more of the following features: The thermostat backplate can include control circuitry configured to disable the light. The control circuitry can be configured to disable illumination of the light in response to the thermostat head unit being attached to the thermostat backplate. The thermostat backplate can include a level. The light can be positioned on the thermostat backplate to illuminate the level. The power wire can be an Rh wire and the control wire can be a W wire or the power wire can be an Rc wire and the control wire can be a Y wire. The power circuitry can include an AC/DC bridge rectifier configured to convert AC received via the plurality of HVAC wires to DC. The power circuitry can include a step-down voltage converter. The thermostat backplate may only receive power from the plurality of HVAC wires and has no onboard battery.

In some embodiments, a method for using a thermostat backplate is presented. The method can include receiving, by a first wire receptacle of the thermostat backplate, a power wire of a plurality of HVAC wires, wherein the plurality of HVAC wires is connected with an HVAC system. The method can include receiving, by a second wire receptacle of the thermostat backplate, a control wire of the plurality of HVAC wires. The method can include illuminating a light of the thermostat backplate using power received via the first wire receptacle and the second wire receptacle. The method may include disabling, by the thermostat backplate, illumination of the light in response to a thermostat head unit being attached with the thermostat backplate.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of a smart thermostat system, in accordance with one embodiment of the present disclosure.

FIG. 2A is an isometric view of a smart thermostat, in accordance with one embodiment of the present disclosure.

FIGS. 2B and 2C are a front view and a side view of a smart thermostat, in accordance with one embodiment of the present disclosure.

FIG. 3A is an exploded front isometric view of a smart thermostat, in accordance with one embodiment of the present disclosure.

FIG. 3B is an exploded rear isometric view of a smart thermostat, in accordance with one embodiment of the present disclosure.

FIGS. 4A and 4B are a front view and a side view of a smart thermostat backplate, in accordance with one embodiment of the present disclosure.

FIG. 4C is an exploded front isometric view of a smart thermostat backplate, in accordance with one embodiment of the present disclosure.

FIG. 5 is a cross section of a side view of a smart thermostat, in accordance with one embodiment of the present disclosure.

FIG. 6 is an enlarged cross section of a side view of a smart thermostat, in accordance with one embodiment of the present disclosure.

FIG. 7 is clip for use with a smart thermostat, in accordance with one embodiment of the present disclosure.

FIG. 8 is an isometric cross section of a side view of a smart thermostat, in accordance with one embodiment of the present disclosure.

FIG. 9 is a flowchart of a method, in accordance with one embodiment of the present disclosure.

FIG. 10 illustrates a block diagram of an embodiment of a thermostat backplate.

FIG. 11 illustrates an embodiment of a thermostat backplate.

FIG. 12 illustrates an embodiment of a method for using a thermostat backplate.

### DETAILED DESCRIPTION

An electronic device refers to a thermostat that can communicate via a network and allows a user to interact with the smart thermostat from a remote location, such as via a mobile device (e.g., smartphone, tablet computer, desktop computer, laptop computer, etc.). Additionally, or alternatively, an electronic device has advanced features such as sensing as to whether any persons are in the vicinity of the smart thermostat and adjusting a setpoint temperature of the thermostat based on the sensed occupancy.

When an electronic device is installed, such as in a user's home, the user may desire that the smart thermostat be relatively easy to interact with and is also aesthetically pleasing. Various embodiments of the present disclosure provide an electronic device having an enlarged display for increased user visibility of available selections on the smart thermostat. Furthermore, at least some embodiments of the present disclosure, optimize a height of the smart thermostat (e.g., measured from a surface that the smart thermostat is mounted to a display surface closest to a user facing the smart thermostat) by compact assembly of the internal components.

The smart thermostat may have a mirrored cover on a face of the thermostat. When the electronic display is turned off, the mirrored cover may have the visual effect of appearing to be a mirror to a user viewing the face of the thermostat. When the electronic display is illuminated, the mirrored cover has a sufficient transmissivity to allow the illuminated portion of the electronic display to be viewed by the user through the cover. In some embodiments, the cover does not have any cutouts, holes, lenses, or variations on the front surface that could be visible to the user.

In some embodiments, a thermostat backplate is presented that can help a user determine if the thermostat backplate is properly installed or there is a problem with the installation. A light can be present on the backplate that is powered only using power obtained from HVAC wiring. That is, no on-board power source, such as a battery, is present. When power and control wires of the HVAC wiring are installed in their proper wire receptacles of the thermostat backplate, and power is present within the wiring, a light on the backplate is illuminated. Therefore, this light can alert the user (and any other party, such as a customer support representative) that: 1) wires are properly installed; and 2) power is present within the wires (e.g., the circuit breaker for the HVAC system is turned on).

Once the light is illuminated, the thermostat head unit can be installed knowing that the backplate and wiring is connected properly and has power. The light can also provide additional benefits: in some embodiments, the light is positioned on the backplate to illuminate a level, which is used to ensure the backplate is installed in a proper orientation on the wall. The proper orientation is necessary to ensure that when the thermostat head unit is installed, it is properly aligned, such as so text is parallel to the floor.

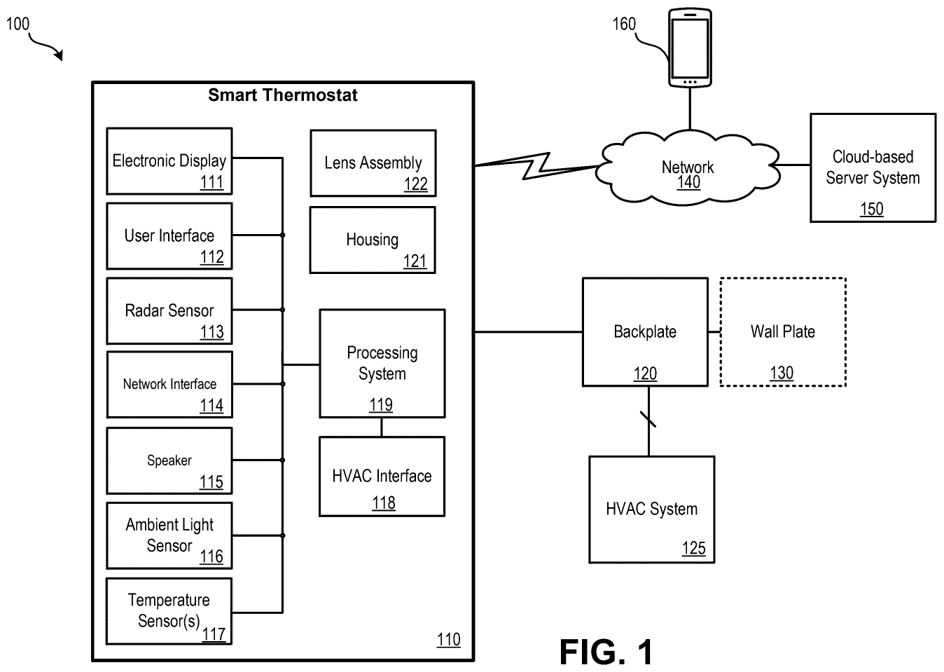

The figures and following description provide additional detail. FIG. 1 is a block diagram of an embodiment of a smart thermostat system. Smart thermostat system 100 can include smart thermostat 110 (which can be referred to as thermostat head unit 110); backplate 120; heating, ventilation, and air conditioning system (HVAC) 125; wall plate 130; network 140; cloud-based server system 150; and computerized device 160. Smart thermostat 110 represents embodiments of the thermostats detailed herein. Thermostat 110 can include: electronic display 111; user interface 112; radar sensor 113; network interface 114; speaker 115; ambient light sensor 116; one or more temperature sensors 117; HVAC interface 118; processing system 119; housing 121; and lens assembly 122.

Electronic display 111 may be visible through lens assembly 122. In some embodiments, electronic display 111 is only visible when electronic display 111 is at least partially illuminated. In some embodiments, electronic display 111 is a touch screen which can allow electronic display 111 to serve as a user interface to receive input. If a touch screen, electronic display 111 can allow one or more gestures, including tap and swipe gestures, to be detected. In some embodiments, the electronic display 111 may include a touch sensor such as a capacitive sensor that includes multiple electrodes positioned within a side wall of the housing 121.

User interface 112 can be various forms of input devices through which a user can provide input to smart thermostat 110. In some embodiments herein, an outer rotatable ring is present as part of user interface 112. The ring can be rotated by a user clockwise and counterclockwise in order to provide input. The ring can be infinitely rotatable in either direction, thus allowing a user to scroll or otherwise navigate user interface menus. The ring (and, possibly, lens assembly 122) can be pressed inward (toward the rear of smart thermostat 110) to function as a “click” or to make a selection. The outer rotatable ring can, for example, allow the user to make temperature target adjustments. By rotating the outer ring clockwise, the target temperature can be increased, and by rotating the outer ring counterclockwise, the target temperature can be decreased. As another example, the ring can be rotated to highlight displayed icons; an inward click can be provided by a user to select a particular icon.

Radar sensor 113 may be configured to output electromagnetic radiation into the ambient environment in front of electronic display 111 of thermostat 110. Radar sensor 113 may be an integrated circuit that includes one or more antennas, one or more RF emitters, and one or more RF receivers. Radar sensor 113 may be able to detect the presence of a user and the distance at which the user is located. Other details of a user may also be detected, such as velocity and whether the user is facing smart thermostat 110. Radar sensor 113 may use frequency-modulated continuous wave (FMCW) radar. Radar sensor 113 may emit electromagnetic radiation and receive reflected electromagnetic radiation through lens assembly 122. Radar sensor 113 may emit chirps of radar that sweep from a first frequency to a second frequency. Therefore, the waveform output by radar sensor 113 may be a sawtooth waveform. Using receive-side beam steering on the reflected radio waves received using multiple antennas, certain regions may be targeted for sensing the presence of users. For instance, beam steering away from the ground may be performed to avoid pets being potentially incorrectly detected as a user.

Network interface 114 may be used to communicate with one or more wired or wireless networks. Network interface 114 may communicate with a wireless local area network, such as a WiFi network. Additional or alternative network interfaces may also be present. For example, smart thermostat 110 may be able to communicate with a user device directly, such as using Bluetooth or some other device-to-device short-range wireless communication protocol. Thermostat 110 may be able to communicate via a mesh network with various other home automation devices, such as using Thread. Mesh networks may use relatively less power compared to wireless local area network-based communication, such as WiFi. In some embodiments, thermostat 110 can serve as an edge router that translates communications between a mesh network and a wireless local area network, such as a WiFi network. In some embodiments, a wired network interface may be present, such as to allow communication with a local area network (LAN). One or more direct wireless communication interfaces may also be present, such as to enable direct communication with a remote temperature sensor installed in a different housing external and distinct from housing 121. The evolution of wireless communication to fifth generation (5G) and sixth generation (6G) standards and technologies provides greater throughput with lower latency which enhances mobile broadband services. 5G and 6G technologies also provide new classes of services, over control and data channels, for vehicular networking (V2X), fixed wireless broadband, and the Internet of Things (IoT). Thermostat 110 may include one or more wireless interfaces that can communicate using 5G and/or 6G networks.

Speaker 115 can be used to output audio. Speaker 115 may be used to output beeps, clicks, synthesized speech, or other audible sounds, such as in response to the detection of user input via user interface 112.

Ambient light sensor 116 may sense the amount of light present in the environment of thermostat 110. Measurements made by ambient light sensor 116 may be used to adjust the brightness of electronic display 111. In some embodiments, ambient light sensor 116 senses an amount of ambient light through lens assembly 122. Therefore, compensation for the reflectivity of lens assembly 122 may be made such that the ambient light levels are correctly determined via ambient light sensor 116. In some embodiments, a light pipe is present between ambient light sensor 116 and lens assembly 122 such that in a particular region of lens assembly 122, light that is transmitted through lens assembly 122, is directed to ambient light sensor 116, which may be mounted to a printed circuit board (PCB), such as a PCB to which processing system 119 is attached.

One or more temperature sensors 117, may be present within thermostat 110. Temperature sensors 117 may be used to measure the ambient temperature in the environment of thermostat 110. One or more additional temperature sensors that are remote from thermostat 110 may additionally or alternatively be used to measure the temperature of the ambient environment.

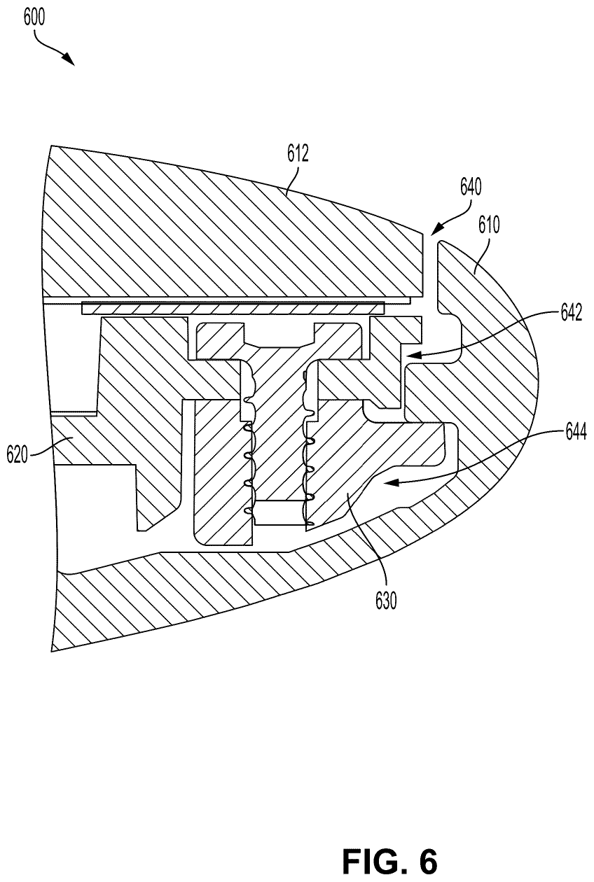

Lens assembly 122 may have a transmissivity sufficient to allow illuminated portions of electronic display 111 to be viewed through lens assembly 122 from an exterior of thermostat 110 by a user. Lens assembly 122 may have a reflectivity sufficient such that portions of lens assembly 122 that are not illuminated from behind appear to have a mirrored effect to a user viewing a front of thermostat 110. Further detail regarding lens assembly 122 are provided in relation to FIGS. 6.

HVAC interface 118 can include one or more interfaces that control whether a circuit involving various HVAC control wires that are connected either directly with thermostat 110 or with backplate 120 is completed. A heating system (e.g., furnace, boiler, heat pump), cooling system (e.g., air conditioner, heat pump), and/or fan may be controlled via HVAC wires by opening and closing circuits that include the HVAC control wires. In some installations, only a heating system or cooling system is controlled by smart thermostat 110; in other embodiments, smart thermostat 110 may control both a heating system and cooling system.

Processing system 119 can include one or more processors. Processing system 119 may include one or more special-purpose or general-purpose processors. Such special-purpose processors may include processors that are specifically designed to perform the functions detailed herein. Such special-purpose processors may be ASICs or FPGAs which are general-purpose components that are physically and electrically configured to perform the functions detailed herein. Such general-purpose processors may execute special-purpose software that is stored using one or more non-transitory processor-readable mediums, such as random access memory (RAM), flash memory, a hard disk drive (HDD), or a solid state drive (SSD) of thermostat 110.

Processing system 119 may output information for presentation to electronic display 111. Processing system 119 can receive information from temperature sensors 117, user interface 112, radar sensor 113, network interface 114, and ambient light sensor 116. Processing system 119 can perform bidirectional communication with network interface 114. Processing system 119 can output information to be output as sound to speaker 115. Processing system 119 can control the HVAC system via HVAC interface 118.

Housing 121 may house and/or attach with all of the components of smart thermostat 110.

Thermostat 110 may be attached (and removed) from backplate 120. Some number of HVAC control wires may be attached with terminals or receptacles of backplate 120. Such HVAC control wires electrically connect backplate 120 with HVAC system 125, which can include a heating system, cooling system, ventilation system, or some combination thereof.

Backplate 120 can allow smart thermostat 110 to be attached and removed from backplate 120 without affecting the electrical connections of the HVAC control wires with backplate 120. In other embodiments, such control wires are directly connected with smart thermostat 110. In some embodiments, wall plate 130 may additionally be installed between backplate 120 and a surface, such as a wall, such as for aesthetic reasons (e.g., cover an unsightly hole through which HVAC wires protrude from the wall.)

Network 140 can include one or more wireless networks, wired networks, public networks, private networks, and/or mesh networks. A home wireless local area network (e.g., a Wi-Fi network) may be part of network 140. Network 140 can include the Internet. Network 140 can include a mesh network, which may include one or more other smart home devices, may be used to enable thermostat 110 to communicate with another network, such as a Wi-Fi network. Thermostat 110 may function as an edge router that translates communications from a relatively low power mesh network received from other devices to another form of network, such as a relatively higher power network, such as a Wi-Fi network.

Cloud-based server system 150 can maintain an account mapped to smart thermostat 110. Thermostat 110 may periodically or intermittently communicate with cloud-based server system 150 to determine whether setpoint or schedule changes have been made. A user may interact with thermostat 110 via computerized device 160, which may be a mobile device, smartphone, tablet computer, laptop computer, desktop computer, or some other form of computerized device that can communicate with cloud-based server system 150 via network 140 or can communicate directly with thermostat 110 (e.g., via Bluetooth or some other device-to-device communication protocol). A user can interact with an application executed on computerized device 160 to control or interact with thermostat 110.

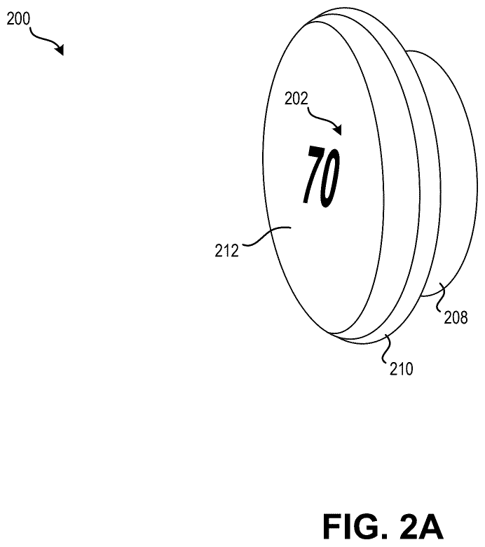

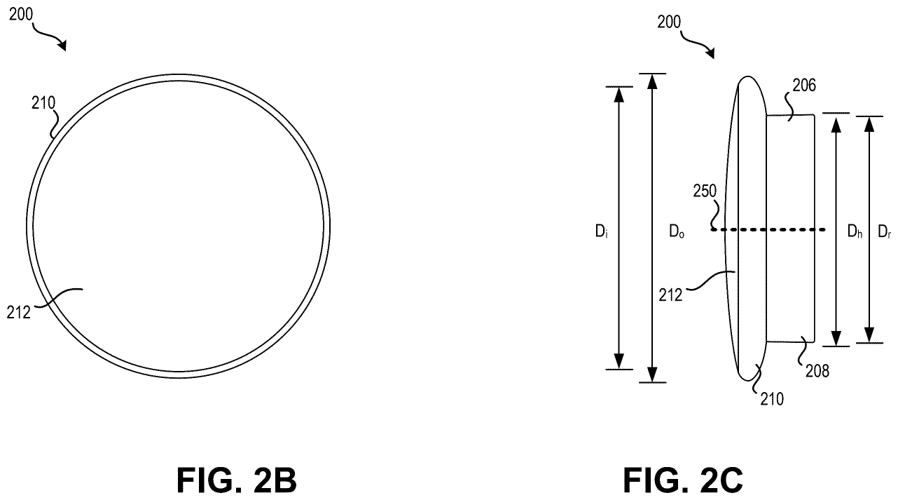

FIG. 2A is an isometric view of an embodiment of a smart thermostat 200. Smart thermostat 200 can represent an embodiment of smart thermostat 110 of FIG. 1. If a thermostat backplate is used, thermostat 200 can be referred to as a thermostat head unit, which is removably connected with a thermostat backplate. In FIG. 2A, electronic display 202, located behind lens assembly 212, is active in displaying a setpoint temperature. The housing of smart thermostat 200 can define sidewall 208. Sidewall 208 may be generally cylindrical according to various embodiments. A diameter of the sidewall 208 may be smaller than a diameter of the electronic display 202 and ring 210 according to various embodiments and as illustrated in FIG. 2A. Ring 210 can function as detailed in relation to user interface 112. Either attached with housing 121 or attached with components connected with housing 121 is lens assembly 212. Lens assembly 212 may include a reflective layer having a reflectivity such that when the electronic display 202 is not illuminated, lens assembly 212 appears to be a mirror when viewed by a user.

In some embodiments, ring 210 is mounted to lens assembly 212. In other embodiments, ring 210 can be rotated clockwise and counterclockwise independent of lens assembly 212. In some embodiments, housing 121 includes a display frame (not visible in this view) that further supports electronic display 202 and lens assembly 212.

Electronic display 202 is housed behind lens assembly 212 such that, when illuminated, the portion of electronic display 202 that is illuminated is visible through lens assembly 212 by a user. In some embodiments, due to the reflectivity of lens assembly 212, an edge of electronic display 202 is not visible to a user regardless of whether electronic display 202 is illuminated, partially illuminated, or not illuminated. Therefore, the overall effect experienced by a user may be that lens assembly 212 appears as a mirror and portions of electronic display 202, when illuminated, are visible through lens assembly 212.

In various embodiments, around an axis perpendicular to the display face of electronic display 202, the ring 210 has an inner diameter and an outer diameter and both the inner diameter and the outer diameter of ring 210 are larger than a diameter of sidewall 208 of housing 121.

FIG. 2B is a front view of an embodiment of smart thermostat 200. When mounted on a wall or other surface, lens assembly 212 is opposite the portion of smart thermostat 200 that mounts to the wall or other surface. Therefore, when a user is facing mounted smart thermostat 200, lens assembly 212 is visible. Lens assembly 212 can form an uninterrupted circular surface with no gaps, holes, lens, or other discontinuities present on the outermost surface of lens assembly 212. Lens assembly 212 has sufficient transmissivity to allow light emitted by electronic display 202 located within housing 206 to be visible through lens assembly 212. Further, lens assembly 212 may have sufficient reflectivity such that a mirrored effect is present on portions of lens assembly 212 that are not currently being illuminated from behind by electronic display 202.

FIG. 2C is a side view of an embodiment of a smart thermostat. When smart thermostat 200 is mounted to a wall or other surface, sidewall 208 of housing 121 is visible. Around an axis 250, the ring 210 has an inner diameter Dᵢ and an outer diameter Dₒ and both the inner diameter Dᵢ and the outer diameter Dₒ of the ring 210 are larger than a diameter Dₕ of sidewall 208 of housing 121. According to various embodiments, sidewall 208 of housing 121 can be generally cylindrical and can have a consistent diameter along a length thereof. Alternatively, a diameter of sidewall 208 can increase as a distance from lens assembly 212 increase.

In some embodiments, ring 210 has a smallest diameter at the rearmost portion of ring 210. Dᵣ is indicative of the diameter of ring 210 where ring 210 meets sidewall 208. This arrangement can help facilitate a user's fingers reaching around ring 210, grasping ring 210, and rotating in either direction. In some embodiments, along axis 250, sidewall 208 may have a diameter of approximately Dᵣ wherein ring 210 and sidewall 208 meet. In some embodiments, the diameter of sidewall 208 can increase as the distance from ring 210 increases.

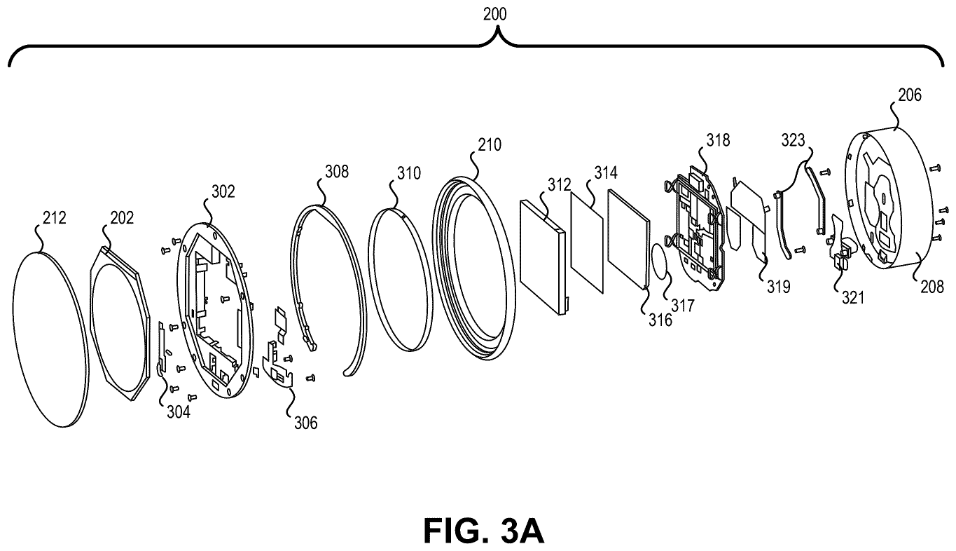

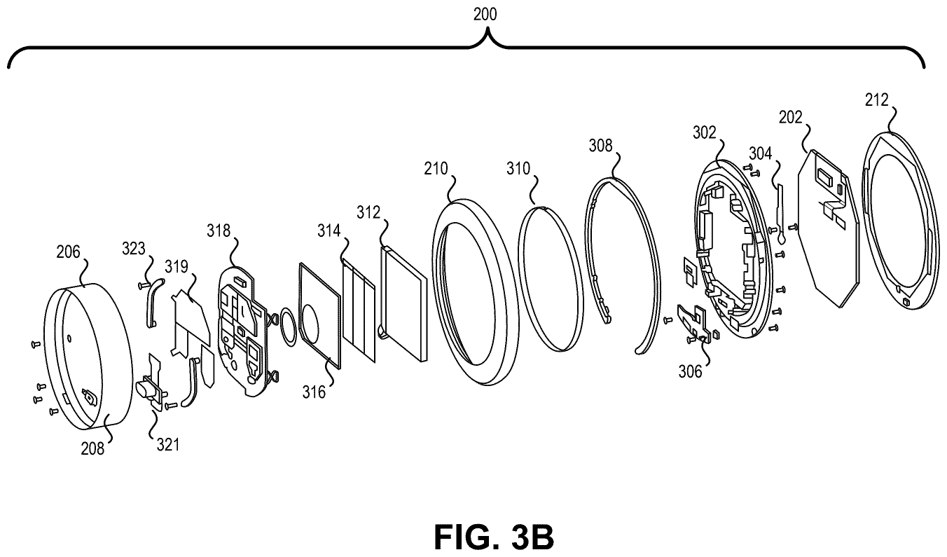

FIG. 3A is an exploded front isometric view of an embodiment of smart thermostat 200. FIG. 3B is an exploded rear isometric view of smart thermostat 200. Viewing the components of the smart thermostat 200 left to right, lens assembly 212 forms an outermost domed surface of smart thermostat 200. Adjacent lens assembly 212 may be electronic display 202. Electronic display 202 may be a liquid-crystal display (LCD) or organic light emitting diode (OLED) display according to various embodiments. In at least some embodiments, one or more adhesives may be used to attach electronic display 202 with lens assembly 212.

Smart thermostat 200 further includes one or more antenna assembly 304 for communicating with a network and/or other electronic devices. Antenna assembly 304 can be used for communicating with wireless local area networks (e.g., WiFi), device-to-device communication (e.g., Bluetooth), and/or communicating with mesh networks (e.g., Thread). Smart thermostat 200 includes one or more sensor boards, such as sensor daughterboard 306. One or more temperature sensors may be installed on sensor daughterboard 306. Use of sensor daughterboard 306 can help isolate the one or more temperature sensors from heat generated by other components.

Smart thermostat 200 may further include clip 308 for coupling ring 210 and display frame 302 supporting electronic display 202. Clip 308 may act as an axial constraint for smart thermostat 200. In particular, clip 308 prevents electronic display 202, display frame 302, and ring 210 from decoupling from one another in the assembled configuration. Clip 308 maintains each of the electronic display 202, display frame 302, and ring 210 relative to a longitudinal axis of the smart thermostat.

As shown in FIG. 3A, smart thermostat 200 can include magnetic strip 310. According to various embodiments, ring 210 rotates relative to sidewall 208 of housing 206 and a backplate when smart thermostat 200 is mounted to a surface. In various embodiments, a sensor installed on a sensor board, such as sensor board 306 and magnetic strip 310 are used for detecting rotation of the ring 210 during use.

According to various embodiments, ring 210 is mounted to housing 206 such that ring 210 can be rotated clockwise and counterclockwise. Ring 210 may include polished stainless steel and a finish applied using physical vapor deposition (PVD). Ring 210 further advantageously provides an aesthetic appearance as the finish of the ring 210 appears seamless relative to lens assembly 212 having a mirrored effect.

Further internal components of smart thermostat 200 include battery 312 and battery adhesive 314. Battery 312 can be a secondary battery and can provide power to the various components of smart thermostat 200, including electronic display 202 and processing system 119. Battery adhesive 314 may be used to adhere battery 312 within housing 206 although the battery 312 (or any other components of the smart thermostat 200) may be secured within the housing 206 using other means. For example, various components may be secured using adhesives, screws, wires, clips, or the like.

Smart thermostat 200 includes processing system 316. According to some embodiments, processing system 316 is a system-on-a-chip (SoC) including various processing parts, memory, modems, etc. Processing system 316 may be in electric communication with one or more antennas present on antenna assembly 304, sensor board 306, electronic display 202, etc., for performing various functions of the smart thermostat 200 and outputting results based on user input (e.g., in response to the user rotating the ring 210 and/or user input via an external mobile device). Adjacent processing system 316 may be piezo sensor 317 for detecting any movement of the smart thermostat 200 (e.g., in the case the smart thermostat 200 becomes dismounted or the like). Additional components of the processing system 316 or components that work with processing system 316 are also shown in FIG. 3. For example, multi-layer board (MLB) 318 may be provided for performing various functions of smart thermostat 200, in a manner that would be appreciated by one having ordinary skill in the art. In some embodiments, MLB 318 may include a Universal Serial Bus (USB) port for electrically coupling smart thermostat 200 to another electronic device for various updates, servicing, or the like. Various springs 319 for supporting components, flexes 321 for enabling flexible and high-density interconnects between printed circuit boards (PCBs), LCDs, etc., and additional links 323 may also be included in the internal components of smart thermostat 200.

Smart thermostat 200 may include more or fewer components than those shown in FIG. 3A. In various embodiments, the components may be in one or more configurations other than the configuration shown in FIG. 3A. Advantageously, various components of smart thermostat 200 are optimized to be condensed into housing 206 such that the overall side profile of smart thermostat 200 is significantly thinner than a side profile of other commercially available smart thermostats.

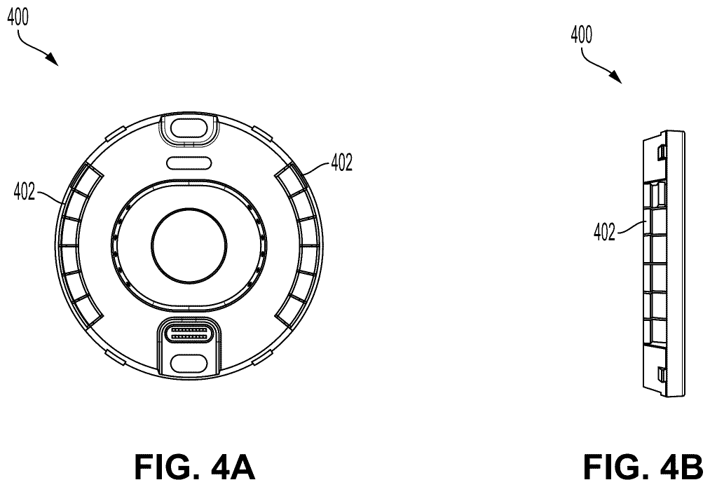

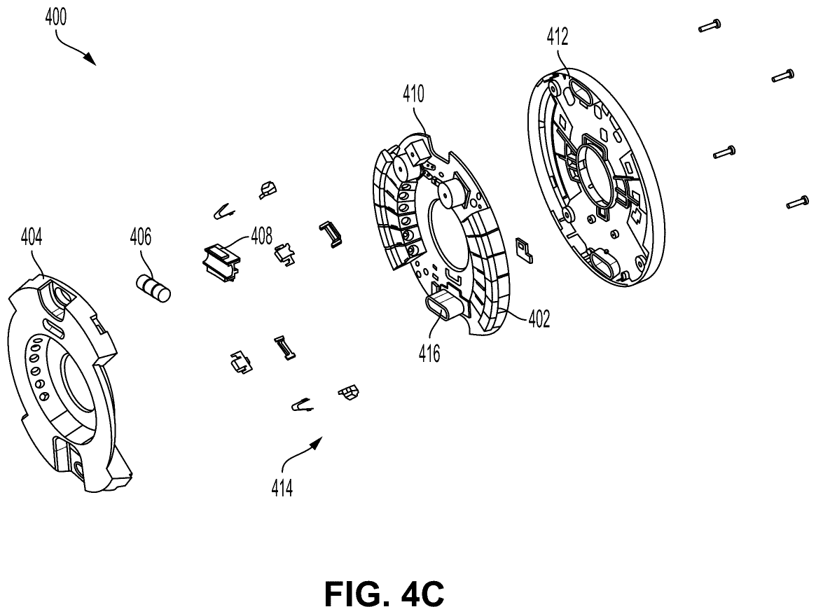

FIGS. 4A and 4B are a front view and a side view of a smart thermostat backplate. According to various embodiments, an electronic device, such as smart thermostat 200 described in detail above, may be mounted to a wall or other surface by thermostat backplate 400. Thermostat backplate 400 may include a plurality of wire terminals 402 for receiving wires that are connected with a heating, ventilation, and cooling (HVAC) system. For example, the backplate 400 may include multiple receptacles, with each receptacle designated to receive a particular HVAC control wire. Backplate 400 can define one or more holes configured to receive fasteners or the like for securing backplate 400 and, if being used, a trim plate or the like, to a surface, such as a wall. The backplate 400 can removably attached with the thermostat housing, such as thermostat housing 206 described above.

In some embodiments, a smart thermostat may be attached (and removed) from backplate 400. HVAC control wires may be attached with terminals or receptacles of backplate 400. Alternatively, such control wires may be directly connected with the smart thermostat. In some embodiments, a trim plate may additionally be installed between the backplate 400 and a surface, such as a wall, such as for aesthetic reasons (e.g., cover an unsightly hole through which HVAC wires protrude from the wall).

FIG. 4C is an exploded front isometric view of the smart thermostat backplate of FIGS. 4A and 4B. Visible in this view, the backplate 400 includes a cap 404, a level 406, a level holder 408, and a coupling plate 410. Various components of the backplate 400 are coupled to one another with one or more fasteners 414. Fasteners 414 may be screws, nails, or some other form of fastener. Fasteners 414 can securely hold backplate 400 and, possibly, a trim plate (not shown) to a surface, such as a wall. A thermostat may removably attach with backplate 400. A user may be able to attach thermostat to backplate 400 by pushing thermostat against backplate 400. Similarly, a user can remove the thermostat from backplate 400 by pulling the thermostat away from backplate 400. When the thermostat is connected with backplate 400, the thermostat is electrically connected various HVAC control wires that have been connected with the receptacles of backplate 400 as would be appreciated by one having ordinary skill in the art.

Further visible in FIG. 4C, a cap 404 for protecting various internal components from damage and for providing an aesthetically pleasing appearance when the electronic device is not mounted to the backplate 400. The cap 404 covers a level 406 for properly mounting the electronic device and/or the backplate 400 to a surface. For example, it would be desirable to have text displayed on the electronic display of the smart thermostat to be straight across (e.g., perpendicular to the ground, etc.). The level 406 may be a bubble level in at least some embodiments. A level holder 408 may be provided to align the level 406 relative to the cap 404, a coupling plate 410, and a base 412. Additional coupling mechanisms may be provided including adhesives, screws, snaps, wires, or the like. The coupling plate 410 may include one or more fasteners as described in detail above. The coupling plate 410 may further include a board-to-board (BTB) connector 416 in some embodiments.

The backplate 400 may include more or less components than those shown in FIGS. 4A-4C. In various embodiments, the components may be in one or more configurations other than the configuration shown in FIGS. 4A-4C. For example, the backplate 400 may be part of a greater thermostat mounting system including a trim plate, batteries, various fasteners, sensors, or the like.

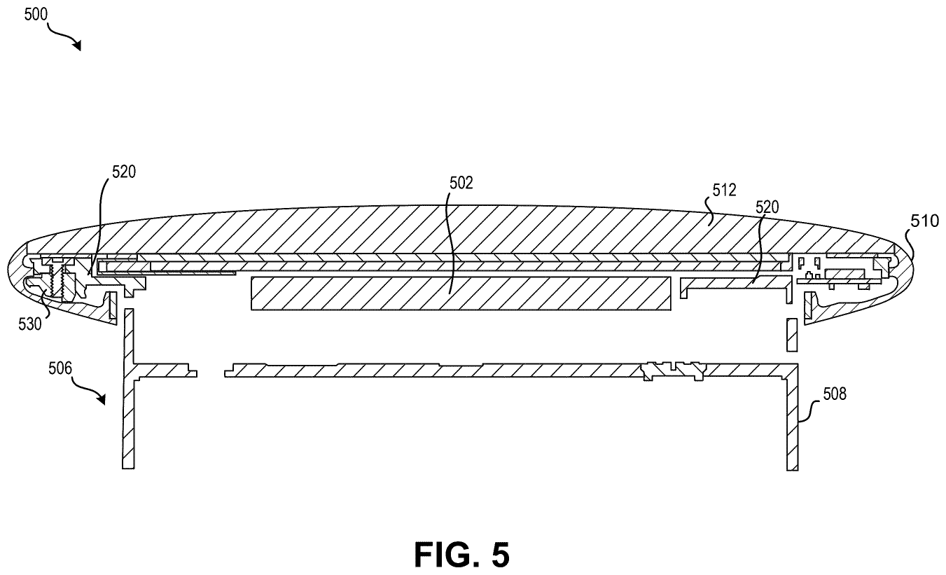

FIG. 5 is a cross section of a side view of a smart thermostat. Smart thermostat 500 may be similar to smart thermostat 200 and similar components may be similarly numbered and have similar form and function unless otherwise noted herein. The domed profile of a domed lens 512 is visible in the cross section of FIG. 5. An electronic display 502 is disposed under the domed lens 512 and surrounded by a ring 510. The electronic display 502 is supported by a display frame 520 as described in detail above. In particular, the ring 510 surrounds the domed lens 512 and couples to the housing 506 having sidewall 508. A clip 530 couples the display frame 520 and the ring 510 as described with respect to other embodiments.

FIG. 6 is an enlarged cross section of a side view of a smart thermostat. Electronic device 600 may be similar to smart thermostat 200 and smart thermostat 500. Similar components may be similarly numbered and have similar form and function unless otherwise noted herein. As shown in FIG. 6, the clip 630, the display frame 620, and the ring 610 are assembled such that a gap 640 is formed between an outer perimeter of the domed lens 612 and a corresponding internal perimeter of the ring 610. In various embodiments, the gap 640 is not visible to the user facing the electronic device 600. For example, the mirrored reflective cover of the domed lens 612 smoothly transitions to the polished finish of the ring 610 with no disruptions. The gap 640 is optimized to be as small as possible while enabling the ring 610 to be rotated relative to the domed lens 612 and/or the electronic display (not shown in this view).

According to various embodiments, the display frame 620 includes a grease trap recess 642 for directing grease between the display frame 620 and the clip 630. For example, grease may be applied between a vertical interface (such as formed by the grease trap recess 642) of the display frame 620 and the ring 610 for continuous rotation of the ring 610 relative to the rest of the electronic device 600 (e.g., including the sidewall of the housing and the backplate) without disruption. In exemplary embodiments, a grease is applied such that the user experiences a pleasing, viscous feeling when rotating the ring 610. The grease may include a damping grease and/or a dry grease. Different types of grease may be applied at different regions between the components unless otherwise noted herein.

In at least some embodiments, the clip 630 is formed to reduce grease shearing between the clip 630 and the ring 610 at location 644. For example, grease applied at the grease trap recess 642 may be displaced to an area proximate location 644. The combination of the tuned gap 640 and grease application enhances the user experience during rotation of the ring 610 and selection of various icons and/or information displayed on the electronic display when the information is visible (e.g., when the electronic display is “ON”) through the domed lens 612.

In various embodiments, one or more temperature sensors (not shown) may be disposed between the ring 610 and the clip 630 and/or the display frame 620. For example, the one or more temperature sensors may be disposed in the portion of the electronic device 600 that overhangs the sidewall (not shown) that mounts the electronic device 600 to a mounting surface. Said another way, the electronic device 600 may form a “mushroom” shape and one or more temperature sensors are disposed proximate an outer perimeter of the “cap” of the mushroom.

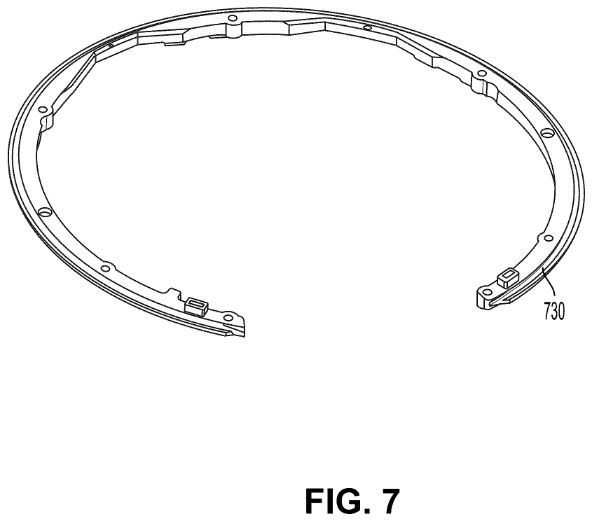

FIG. 7 is clip for use with a smart thermostat. The clip 730 may be of the same type as various clips described herein. The clip 730 may be a C-clip as shown in FIG. 7. The clip 730 acts as an axial constraint for various components of the electronic device and couples at least the display frame and the ring. The clip 730 is optimized for assembly such that the clip 730 is relatively thin within the electronic device housing. The open end of the clip 730 as shown in FIG. 7 enables efficient installation and removal of the clip 730 during servicing or other activities involving disassembling the electronic device.

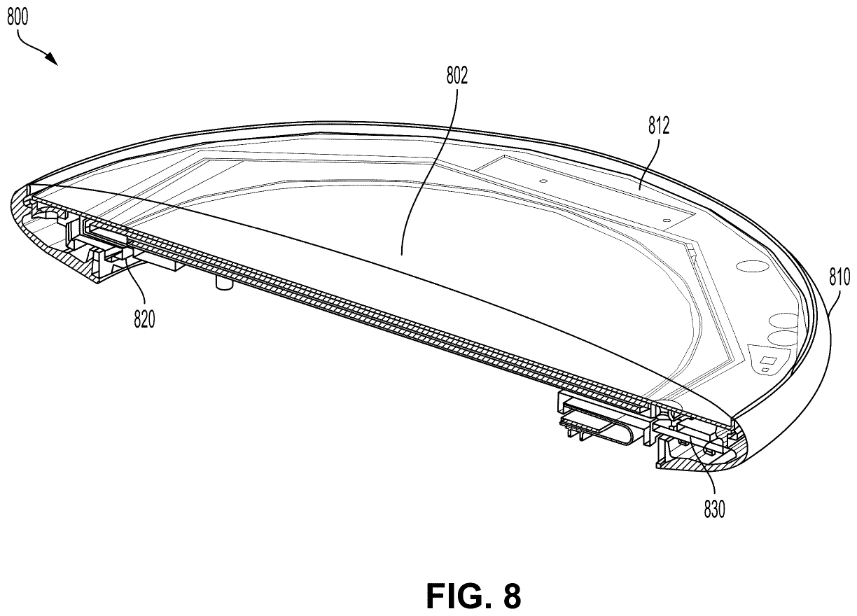

FIG. 8 is an isometric cross section of a side view of a smart thermostat. FIG. 8 provides another view of the various electronic devices described in detail above. In particular, electronic device 800 may be similar to other electronic devices described above and similar components may be similarly numbered and have similar form and function unless otherwise noted herein. The domed profile of a domed lens 812 is visible in the cross section of FIG. 8. An electronic display 802 is disposed under the domed lens 812 and supported by a ring 810 and a display frame 820 as described in detail above. In particular, the ring 810 surrounds the domed lens 812. The clip 830 couples the display frame 820 supporting the electronic display 802 to the housing (not shown).

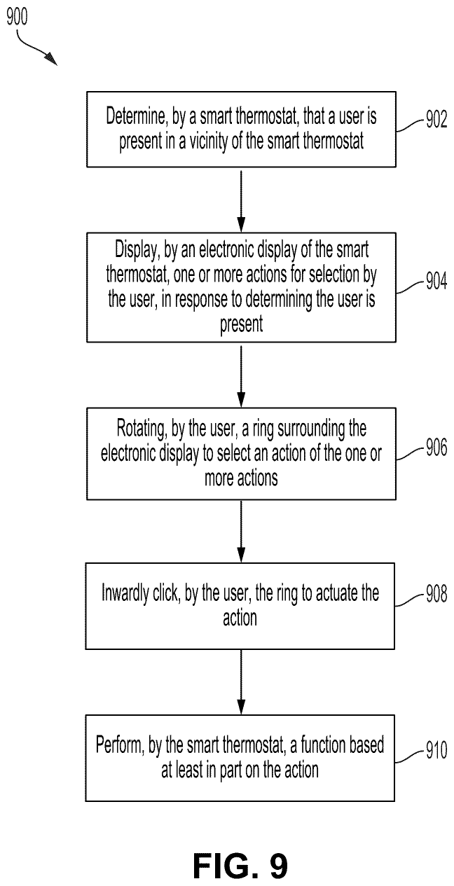

FIG. 9 is a flowchart of a method, in accordance with one embodiment of the present disclosure. In particular, FIG. 9 illustrates a method 900 for interacting with a smart thermostat such as the electronic devices described in detail above. Method 900 includes step 902. Step 902 includes determining, by a smart thermostat, that a user is present in a vicinity of the smart thermostat. The smart thermostat may include any of the embodiments described in detail above.

Step 904 includes displaying, by an electronic display of the smart thermostat, one or more actions for selection by the user, in response to determining that the user is present in the vicinity of the smart thermostat. For example, a user interface may become visible through a reflective cover covering the electronic display. The reflective cover may be a domed lens secured relative to the housing of the smart thermostat. The reflective cover may have a reflectivity sufficient to produce a mirrored effect when viewed and a transmissivity sufficient to allow illuminated portions of an electronic display of the smart thermostat to be visible when viewed through the reflective cover.

Method 900 may further include step 906. Step 906 includes rotating, by the user, a ring surrounding the electronic display to select an action of the one or more actions. For example, the electronic display may display a thermostat, a plurality of icons, text, images, or the like, that are indicative of various actions to be performed by the smart thermostat. A user can interact with presented menus, icons, and other data presented on the electronic display. Action may be used interchangeably with menus, icons, and other data as would be appreciated by one having ordinary skill in the art upon reading the present disclosure. Icons or graphics may be used to indicate at least some information graphically. For example, weather information may be indicated using graphics such as the sun, clouds, rain, snow, wind, etc. A graphic indicating a temperature that corresponds to the indoor temperature may include a graphic of a house. A graphic indicating the relative humidity may be a raindrop. The user may rotate the ring, as described in detail above, to select an action of the one or more actions.

Method 900 may further include step 908. Step 908 includes inwardly clicking, by the user, the ring to actuate the action. For example, the ring may be separate from the electronic display such that the ring may be rotated and inwardly clicked without rotating the display. Step 908 may include receiving, by the smart thermostat, user input via rotation of a ring surrounding the electronic display for selecting an icon. A ring as described in detail above may be rotated to select one or more icons, a series of icons, etc., on the electronic display. In at least some embodiments, the smart thermostat may receive additional user input from a user tap or push gesture of the domed lens including the electronic display. In yet other embodiments, the smart thermostat may receive additional user input from a user's swipe gesture across the domed lens. In some embodiments, color is used to emphasize the selected icon. In order to return back to the default interface, a user may highlight and select a back icon, which in some embodiments is represented by an arrow pointed left. Selection of an icon may be accomplished by a user tapping a touch sensor or the like while the icon is emphasized.

Method 900 may further include step 910. Step 910 includes performing, by the smart thermostat, a function based at least in part on the selection of the icon. A function of the smart thermostat may include activating an HVAC system, deactivating an HVAC system, adjusting a control schedule used to control the HVAC system, adjusting a setpoint of the HVAC system, altering the settings of the thermostat, etc.

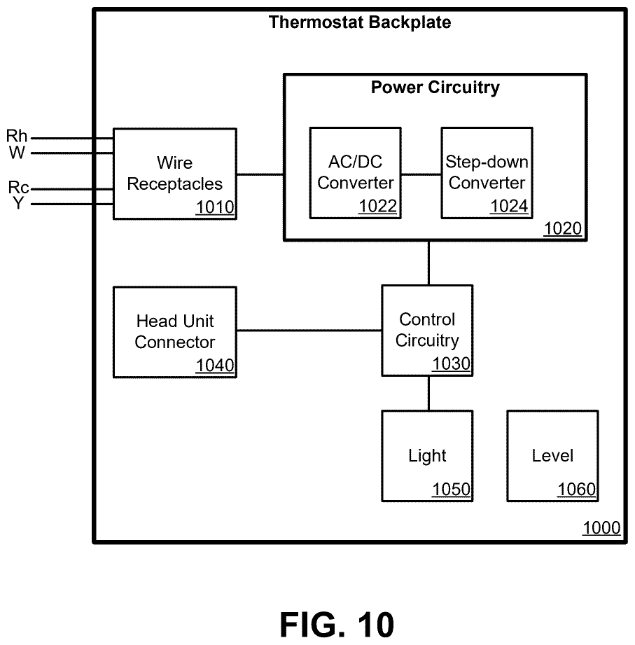

Further detail is provided in relation to FIGS. 10-12 regarding using a thermostat backplate with an integrated light. A thermostat backplate is removably connected with a thermostat head unit. HVAC wires can first be connected with the backplate with the thermostat head unit then being plugged into the thermostat backplate. FIG. 10 illustrates a block diagram of an embodiment of a thermostat backplate 1000. Thermostat backplate 1000 can include: wire receptacles 1010; power circuitry 1020; control circuitry 1030; head unit connector 1040; light 1050; and level 1060. Also present is a housing used to house each of the components of thermostat backplate 1000. Thermostat backplate 1000 can represent various embodiments of thermostat backplate 400 FIGS. 4A and 4B.

Wire receptacles 1010 are configured to receive, hold, and make electrical connections with various HVAC system wires. Wire receptacles 1010 are removably attachable with HVAC system wires; therefore, HVAC system wires can be installed and removed from wire receptacles 1010. Each of wire receptacles 1010 is configured to receive a particular HVAC wire and can be labeled as such. Many different types of HVAC wires are possible, including: Rh (heating system power, may also be labeled R and is typically red in color); Rc (cooling system power, typically red in color); C (common, typically blue); G (fan control wire, typically green); Y (air conditioning compressor control wire, typically yellow); W (heating system control wire, typically white); O (heat pump control wire, typically orange). The most common HVAC wires are Rh, W, Rc, and Y. Depending on the HVAC system, varying HVAC wires can be used. For example, if only heating is present, only an Rh (or R) and W HVAC wires may be present. If heating and cooling are present, Rh (or R), W, Rc, Y, and G may be present, for example.

For all HVAC wires that are in use, the HVAC wires are connected with the corresponding wire receptacles of wire receptacles 1010. As illustrated, Rh, W, Rc, and Y are shown. In other embodiments, as few as two of these wires may be present—one control wire and one power wire. Alternatively, more HVAC wires may be connected with wire receptacles 1010. In some embodiments, some of these wires, such as Rh and Rc, provide 24 V AC power.

Power circuitry 1020 may be used to convert the power received via wire receptacles 1010 to power that can be used to illuminate a light. Power circuitry 1020 may include an AC/DC converter 1022. For example, an AC/DC bridge rectifier can be used. AC/DC converter 1022 can be connected with wire receptacles 1010 such that, as long as one pair of power/control wires is properly connected and powered, AC/DC converter 1022 can create DC power. For example, a first pair of Rh and W may be used, a second pair of Rc and Y, or both, to generate the DC power. If a wire is connected to the wrong wire receptacle of wire receptacles 1010, or the HVAC system is not powered, no DC voltage may be generated by AC/DC converter 1022; and thus, light 1050 cannot illuminate.

In some embodiments, at least one pair of Rh/W and Rc/Y must be connected in the proper wire receptacles of wire receptacles 1010 and powered, in order for light 1050 to illuminate. In other embodiments, additional installation arrangements can be present that provide feedback through one or more lights. For example, feedback as to whether the wiring of a single or multi-stage heat pump, multi-stage cooling system, fan, and common wire can be provided via one or more lights. For example, if a common wire is not properly installed (but Rh/W or Rc/Y are installed correctly), control circuitry 1030 could cause an additional light to either illuminate or not illuminate or could cause light 1050 to flash.

Power circuitry 1020 can also include a step-down converter 1024, which can also be received as a Buck converter. Step-down converter 1024 is a DC-to-DC converter that decreases the DC voltage level to a desired voltage, such as between 3 V and 5 V (e.g., 4.4 V).

Power circuitry 1020 can be connected with control circuitry 1030. Control circuitry 1030 can control whether light 1050 is activated. There can be certain situations where, even if power is present, light 1050 is not to be activated. Once a thermostat head unit is connected with head unit connector 1040, control circuitry 1030 can deactivate light 1050. (Since the thermostat head unit blocks the visibility of light 1050, using power to illuminate light 1050 would be a waste.) If the thermostat head unit is removed from head unit connector 1040, control circuitry 1030, again, allows light 1050 to be illuminated, assuming DC power is provided by power circuitry 1020. Light 1050 can be a light emitting diode (LED) that can output a single color (e.g., white). In other embodiments, multiple LEDs may be used, possibly which output different colors.

Notably, no on-board power source, such as a battery, is present in thermostat backplate 1000. Therefore, if light 1050 is illuminated, it is known that power is being received from the wires connected with wire receptacles 1010.

Thermostat backplate 1000 can further house level 1060. Level 1060 can be used to ensure that the thermostat backplate is installed level on a wall such that, when head unit connector 1040, the text presented by the thermostat head unit will appear parallel with the floor. Light 1050 can be attached to the housing of thermostat backplate 1000 such that level 1060 is illuminated. Illuminating level 1060 can make it easier for a user to see the bubble within level 1060 and to level thermostat backplate 1000.

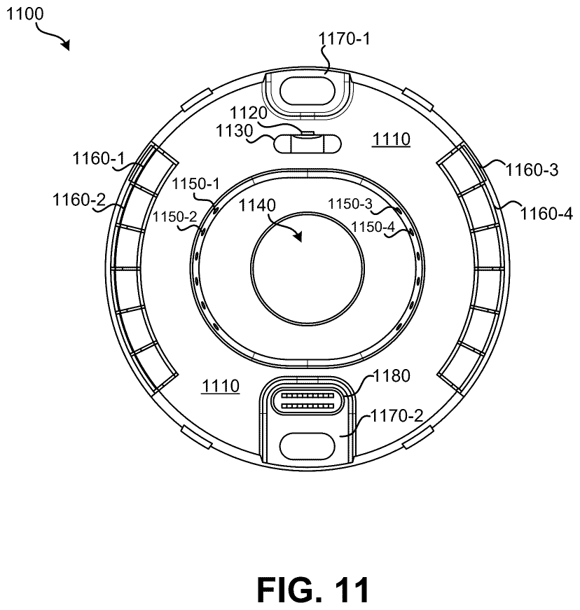

FIG. 11 illustrates an embodiment of a thermostat backplate 1100. Thermostat backplate 1100 can represent an embodiment of thermostat backplate 1000 of FIG. 10. Thermostat backplate housing 1110 can define one or more fastener openings 1170 to allow fasteners (e.g., screws, nails) to be used to affix thermostat backplate 1100 to a surface, such as a wall.

Thermostat backplate 1000 may further define HVAC wiring pass-through 1140. All HVAC wires may pass through backplate housing 1110 from within a wall or surface, to which backplate housing 1110 is attached or is to be attached. Protruding wires are then inserted into the corresponding wire receptacles 1150. Printed labels or colors may be present on backplate housing 1110, wire terminals 1160, or elsewhere on thermostat backplate 1100 to identify the HVAC wire that should be inserted into each of wire receptacles 1150. A wire terminal (e.g., wire terminal 1160-1) of wire terminals 1160 may be depressed by the user when a wire is inserted into the corresponding wire receptacle 1150-1 of wire receptacles 1150. When released, wire terminal 1160-1 can exert force on the wire to hold it in place and to form an electrical connection. Wire terminal 1160-1 can remain at least partially depressed while the wire is installed. Wires can be removed by depressing the corresponding wire terminal and pulling the wire out from its wire receptacle.

In the illustrated embodiment of thermostat backplate 1100, light 1120 is housed by backplate housing 1110 such that light 1120, when illuminated, shines into level 1130. Therefore, when illuminated, light 1120 can help make the bubble within level 1130 easier to see and align within the center of level 1130. A procedure for installing thermostat backplate 1100, from the perspective of a user, can be: (1) disable power to the HVAC system; (2) insert HVAC wires through pass-through 1140; (3) install one or more fasteners through fastener opening 1170-1 and fastener opening 1170-2 (possibly without fully tightening at least one of the fasteners to allow for adjustment of the orientation of thermostat backplate 1100); (4) insert each HVAC wire to be used to control the HVAC system into the corresponding wire receptacle (along with depressing the corresponding wire terminal); (5) enable power to the HVAC system (at this point, light 1120 should illuminate, assuming each wire is properly seated in the correct wire terminal); (6) level thermostat backplate 1100 using illuminated level 1130; (7) tighten fasteners in fastener opening 1170-1 and fastener opening 1170-2; and, finally, (7) couple the thermostat head unit to thermostat backplate 1100.

The specific design of thermostat backplate 1100 varies by embodiment. For example, the circular shape of thermostat backplate 1100 can be varied, along with the arrangement of wire receptacles 1150 and wire terminals 1160. Level 1130 and light 1120 do not need to be centered on backplate housing 1110.

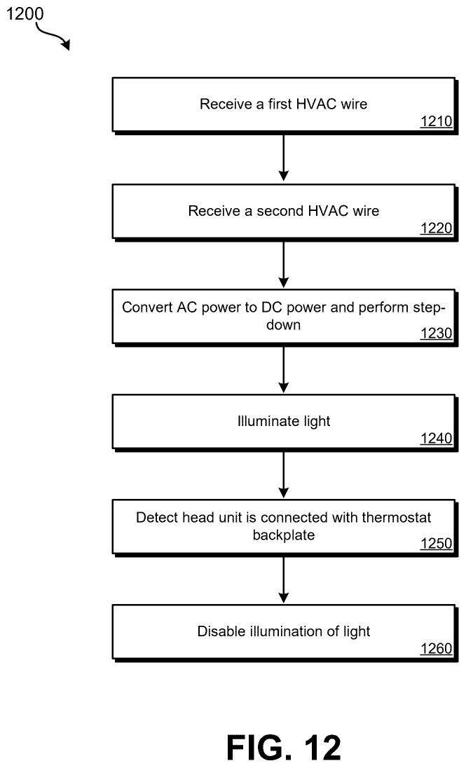

Various methods can be performed using the backplates of FIGS. 10 and 11. FIG. 12 illustrates an embodiment of a method 1200 for using a thermostat backplate, as detailed in relation to FIG. 10 or FIG. 11. Prior to block 1210 of method 1200, power may have been disabled by a user to the one or more HVAC systems for which wiring is being installed to the thermostat backplate. Typically, disabling power includes turning off a breaker or removing a fuse through which power is supplied to the HVAC systems.

At block 1210, a first HVAC wire is received by the thermostat backplate. This HVAC wire can be a power wire (e.g., Rh or Rc). Receiving the first HVAC wire includes inserting the HVAC wire into a corresponding wire receptacle (e.g., labeled as R, Rh, or Rc) and holding the wire in place, such as by engaging a corresponding wire terminal. At block 1220, a second HVAC wire is received by the thermostat backplate. This second HVAC wire can be a control wire (e.g., W or Y). Receiving the second HVAC wire is performed using the same procedure as the first HVAC wire for the appropriate wire terminal. Additional HVAC wires can also be installed after block 1220 such that all HVAC wires to be used to control one or more HVAC systems are connected with the backplate in the corresponding wire receptacles.

Following block 1220, the user may re-enable power to the one or more HVAC systems. Thus, power will be supplied via the Rh, Rc, or both wires. Assuming the wires of blocks 1210 and 1220 are properly installed into the corresponding wire terminals, AC power can be converted to DC power at block 1230. Additionally, a voltage step-down may be performed. In other embodiments, such as one in which a light uses AC power, block 1230 may not be necessary.

At block 1240, the light may be illuminated. At block 1240, the thermostat head unit is not yet installed. The circuit created to illuminate the light, which can use Rh and W, Rc and Y, or both, may not cause sufficient current on the W and/or Y wires to trigger the HVAC system to turn on. As long as power is supplied via the HVAC wires and the HVAC wires remain connected with the proper wire terminals, the light may stay illuminated until block 1260. If the light does not illuminate at block 1240, the user is thereby alerted that either the HVAC wires are not powered or not correctly installed with the backplate.

At block 1250, control circuitry can detect that the thermostat head unit has been connected with the thermostat backplate. For example, two pins of the thermostat head unit connector may be shorted together. In response to block 1250, illumination of the light is disabled. The light may remain disabled from illuminating as long as the thermostat head unit is connected to the thermostat backplate. If removed, as long as power is present in the HVAC wires and the HVAC wires remain properly connected with the correct wire terminals of the thermostat backplate, the light may, again, be illuminated at block 1240.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves; and thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known, processes, structures, and techniques have been shown without unnecessary detail in order to avoid obscuring the embodiments. This description provides example embodiments only and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A smart thermostat system, comprising:
a thermostat head unit; and
a thermostat backplate configured to be removably attached with the thermostat head unit, the thermostat backplate comprising:
a plurality of wire receptacles that receive a plurality of HVAC wires that are electrically connected with an HVAC system;
power circuitry that is configured to output power when a power wire is powered and the power wire and a control wire of the plurality of HVAC wires are connected with correct wire receptacles of the plurality of wire receptacles of the thermostat backplate; and
a light that illuminates using power output by the power circuitry.

2. The smart thermostat system of claim 1, wherein the thermostat backplate further comprises control circuitry configured to disable illumination of the light.

3. The smart thermostat system of claim 2, wherein the control circuitry is configured to disable illumination of the light in response to the thermostat head unit being attached to the thermostat backplate.

4. The smart thermostat system of claim 1, wherein:
the thermostat backplate further comprises a level; and
the light is positioned on the thermostat backplate to illuminate the level.

5. The smart thermostat system of claim 1, wherein the power wire is an Rh wire and the control wire is a W wire.

6. The smart thermostat system of claim 1, wherein the power wire is an Rc wire and the control wire is a Y wire.

7. The smart thermostat system of claim 1, wherein the power circuitry comprises an AC/DC bridge rectifier configured to convert AC received via the plurality of HVAC wires to DC.

8. The smart thermostat system of claim 7, wherein the power circuitry further comprises a step-down voltage converter.

9. The smart thermostat system of claim 1, wherein the thermostat backplate only receives power from the plurality of HVAC wires and has no onboard battery.

10. The smart thermostat system of claim 1, further comprises the HVAC system, which outputs 24 V alternating current (AC) via the power wire, and the HVAC system comprises a heating system, a cooling system, or both.

11. A thermostat backplate, comprising:
a housing configured to be attached with a wall and removably attached with a thermostat head unit;
a plurality of wire receptacles, housed by the housing, that receive a plurality of HVAC wires that are electrically connected with an HVAC system;
power circuitry, housed by the housing, that is configured to output power when a power wire and a control wire of the plurality of HVAC wires are powered and connected with correct wire receptacles of the plurality of wire receptacles of the thermostat backplate; and
a light, housed by the housing, that illuminates using power obtained from the power circuitry.

12. The thermostat backplate of claim 11, wherein the thermostat backplate further comprises control circuitry configured to disable the light.

13. The thermostat backplate of claim 12, wherein the control circuitry is configured to disable illumination of the light in response to the thermostat head unit being attached to the thermostat backplate.

14. The thermostat backplate of claim 11, wherein:
the thermostat backplate further comprises a level; and
the light is positioned on the thermostat backplate to illuminate the level.

15. The thermostat backplate of claim 11, wherein the power wire is an Rh wire and the control wire is a W wire or the power wire is an Rc wire and the control wire is a Y wire.

16. The thermostat backplate of claim 11, wherein the power circuitry comprises an AC/DC bridge rectifier configured to convert AC received via the plurality of HVAC wires to DC.

17. The thermostat backplate of claim 16, wherein the power circuitry further comprises a step-down voltage converter.

18. The thermostat backplate of claim 11, wherein the thermostat backplate only receives power from the plurality of HVAC wires and has no onboard battery.

19. A method for using a thermostat backplate, comprising:
receiving, by a first wire receptacle of the thermostat backplate, a power wire of a plurality of HVAC wires, wherein the plurality of HVAC wires is connected with an HVAC system;
receiving, by a second wire receptacle of the thermostat backplate, a control wire of the plurality of HVAC wires; and
illuminating a light of the thermostat backplate using power received via the first wire receptacle and the second wire receptacle.

20. The method for using the thermostat backplate of claim 19, further comprising:
disabling, by the thermostat backplate, illumination of the light in response to a thermostat head unit being attached with the thermostat backplate.
